(19) United States
(12) Patent Application Publication
(10) Pub. No.: US 2013/0248283 A1
(43) Pub. Date: Sep. 26, 2013

(54) RECYCLABLE ACOUSTIC ABSORBENT AND MANUFACTURING METHOD THEREOF

(71) Applicants: Hyeon Ho Kim, Gunpo (KR); Jenong-Woo Choi, Chungbuk (KR)

(72) Inventors: Hyeon Ho Kim, Gunpo (KR); Jenong-Woo Choi, Chungbuk (KR)

(73) Assignees: HyundaiI Motor Company, Seoul (KR); Iksung Co., Ltd., Chungbuk (KR); Kia Motors Corporation, Seoul (KR)

(21) Appl. No.: 13/546,250

(22) Filed: Jul. 11, 2012

(30) Foreign Application Priority Data
Mar. 21, 2012 (KR) 10-2012-0028853

(51) Int. Cl. E04B 1/84; B29C 47/02

(52) U.S. Cl. 181/294; 264/103

(57) ABSTRACT

Disclosed is an acoustic absorbent including a fiber web formed of a melt-blown fiber and a polypropylene staple fiber, wherein the melt-blown fiber is prepared by melt-extruding a resin composition including a homo polypropylene and a polypropylene-based elastomer. Tensile elongation of the acoustic absorbent is improved as the content of the polypropylene-based elastomer increases. Due to excellent fitting property, the acoustic absorbent has excellent fitting property and, thus, can be efficiently fixed in a product with a complicated surface appearance. Further, by using a predetermined content of a polypropylene-based elastomer, the acoustic absorption performance of the acoustic absorbent is considerably improved.

### CROSS-REFERENCE TO RELATED APPLICATION

This application claims under 35 U.S.C. §119(a) the benefit of Korean Patent Application No. 10-2012-0028853 filed Mar. 21, 2012, the entire contents of which are incorporated herein by reference.

### BACKGROUND

1. Field of the Invention

The present invention relates to an acoustic absorbent and a method of manufacturing the same, and more particularly, to a recyclable acoustic absorbent and a method of manufacturing the same.

2. Description of the Related Art

Various acoustic absorbents are typically applied to vehicles in order to reduce engine noise, wind noise, tire noise, and the like. These acoustic absorbents should block or absorb noise and vibration in the interior of vehicles and prevent low frequency and high frequency noise from being transmitted into vehicles.

In order to reduce noise in vehicles, various types of materials have been developed.

Korean Patent Application Publication No. 2005-93950 describes an interior material for automobiles including a non-woven fabric layer and a shaped yarn layer combined and deformed in a spring shape. The non-woven fabric layer is formed of a general fiber and a predetermined amount of a hollow fiber.

Korean Patent Application Publication No. 2007-118731 describes a sound absorber including a non-woven fabric of nano fibers having an average diameter of 1000 nm or less.

Korean Patent Application Publication No. 2008-55929 describes multilayer articles having acoustical absorbing properties including a support layer, such as a melt-blown fiber, and a sub-micron fiber layer formed on the support layer. The sub-micron fiber layer includes polymeric fibers having a diameter of less than 1 μm or less.

However, these materials are limited. For example, insufficient sound absorption performance is provided by an acoustic absorbent formed of a non-woven fabric prepared by the melt-blown manufacturing process. Further, non-woven fabrics consisting of a mixture of different materials having different chemical properties cannot be recycled.

### SUMMARY OF THE INVENTION

The present invention provides a recyclable acoustic absorbent having excellent acoustic absorption performance and a method of manufacturing the same. According to various embodiments, the absorbent includes a mixture of different materials, such as a mixture of two different materials, with different chemical properties. The present invention further provides a recyclable acoustic absorbent having excellent elasticity, elongation, and fitting property.

According to one aspect, the present invention provides an acoustic absorbent in the form of a fiber web that comprises a combination of a melt-blown fiber and a polypropylene staple fiber. According various embodiments, the melt-blown fiber comprises a combination of a homopropylene and a polypropylene-based elastomer, for example, about 90 to 99 wt % of a homo polypropylene and about 1 to 10 wt % of a polypropylene-based elastomer. According to an exemplary embodiment, the melt-blown fiber is prepared by melt-extruding a resin composition comprising about 90 to 99 wt % of a homo polypropylene and about 1 to 10 wt % of a polypropylene-based elastomer.

According to another aspect, the present invention provides a method of manufacturing a recyclable acoustic absorbent having excellent elasticity, elongation, and fitting property. According to various embodiments,

a method of manufacturing an acoustic absorbent, is provided which comprises:

melt-extruding a resin composition comprising a combination of a homo polypropylene and a polypropylene-based elastomer;

forming the melted thermoplastic resin into a melt-blown fiber shape using gas ejection;

adding a staple fiber to the ejected melt-blown fiber;

capturing the ejected melt-blown fiber and the staple fiber to form a fiber web; and

winding the captured fiber web.

According to various embodiments, the resin composition comprises about 90 to 99 wt % of a homo polypropylene and about 1 to 10 wt % of a polypropylene-based elastomer. According to various embodiments, the staple fiber is a polypropylene staple fiber.

Further objectives and advantages of the present invention will be understood in more detail through the description below, claims, and accompanying drawings. The present invention provides an acoustic absorbent having numerous advantages, and method for its manufacture. In particular an acoustic absorbent of the present invention is provided with a tensile elongation that improves as the content of the polypropylene-based elastomer in the resin composition increases. In particular, tensile elongation of the acoustic absorbent can be improved by about 16% to 54% as compared with an acoustic absorbent that does not contain a polypropylene-based elastomer.

Further, the acoustic absorbent material is provided an excellent fitting property and, thus, it can be efficiently fixed in a variety of products, even those having a complicated surface on which the material is fixed.

Still further, the acoustic absorption performance of an acoustic absorbent according to the present invention is considerably improved by providing a predetermined content of a polypropylene-based elastomer in a resin composition used to form a melt-blown fiber.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIG. 1 schematically illustrates an apparatus for manufacturing an acoustic absorbent according to an embodiment of the present invention;

FIG. 2 schematically illustrates an apparatus for manufacturing an acoustic absorbent according to another embodiment of the present invention;

FIG. 3 is a graph illustrating acoustic absorption performance of acoustic absorbents manufactured according to Examples 1, 7, and 13 and Comparative Examples 1 and 2, wherein the contents of the polypropylene staple fiber are the same (5 wt % based on the weight of the fiber web), and the contents of the polypropylene-based elastomer are 1 wt % (Example 1), 5 wt % (Example 7), and 10 wt % (Example 13) based on the total weight of the resin composition, respectively;

FIG. 4 is a graph illustrating acoustic absorption performance of acoustic absorbents manufactured according to Examples 2, 8, and 14 and Comparative Examples 1 and 2, wherein the contents of the polypropylene staple fiber are the same (10 wt % based on the weight of the fiber web), and the contents of the polypropylene-based elastomer are 1 wt % (Example 2), 5 wt % (Example 8), and 10 wt % (Example 14) based on the total weight of the resin composition, respectively;

FIG. 5 is a graph illustrating acoustic absorption performance of acoustic absorbents manufactured according to Examples 3, 9, and 15 and Comparative Examples 1 and 3, wherein the contents of the polypropylene staple fiber are the same (20 wt % based on the weight of the fiber web), and the contents of the polypropylene-based elastomer are 1 wt % (Example 3), 5 wt % (Example 9), and 10 wt % (Example 15) based on the total weight of the resin composition, respectively;

FIG. 6 is a graph illustrating acoustic absorption performance of acoustic absorbents manufactured according to Examples 4, 10, and 16 and Comparative Examples 1 and 4, wherein the contents of the polypropylene staple fiber are the same (30 wt % based on the weight of the fiber web), and the contents of the polypropylene-based elastomer are 1 wt % (Example 4), 5 wt % (Example 10), and 10 wt % (Example 16) based on the total weight of the resin composition, respectively;

FIG. 7 is a graph illustrating acoustic absorption performance of acoustic absorbents manufactured according to Examples 5, 11, and 17 and Comparative Examples 1 and 5, wherein the contents of the polypropylene staple fiber are the same (40 wt % based on the weight of the fiber web), and the contents of the polypropylene-based elastomer are 1 wt % (Example 5), 5 wt % (Example 11), and 10 wt % (Example 17) based on the total weight of the resin composition, respectively; and

FIG. 8 is a graph illustrating acoustic absorption performance of acoustic absorbents manufactured according to Examples 6, 12, and 18 and Comparative Examples 1 and 6, wherein the contents of the polypropylene staple fiber are the same (50 wt % based on the weight of the fiber web), and the contents of the polypropylene-based elastomer are 1 wt % (Example 6), 5 wt % (Example 12), and 10 wt % (Example 18) based on the total weight of the resin composition, respectively.

### DETAILED DESCRIPTION OF THE INVENTION

Hereinafter, an acoustic absorbent and a method of manufacturing the same according to one or more embodiments of the present invention will be described more fully with reference to the accompanying drawings, in which exemplary embodiments of the invention are shown.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

As used herein, the term “melt-blown fiber” refers to a fiber formed by extruding a molten processable polymer through a plurality of fine capillary tubes with hot and high-speed compressed air.

In this regard, the capillary tube may have various cross-sectional shapes such as, for example, a polygon including a circle, a triangle, and a tetragon, and a star shape. In addition, the hot and high-speed compressed gas may reduce the diameter of a filament of a melted thermoplastic polymeric material to a suitable diameter such as, for example, about 0.5 to 10 μm. The melt-blown fiber may be discontinuous or continuous fiber. The melt-blown fiber may be nonuniformly deposited on a capturing device, such as that described herein, so as to form a web of randomly distributed fibers.

As used herein, the term “spunbonded non-woven fabric” refers to a fiber web prepared by elongating a plurality of fibers having a fine diameter, wherein the plurality of fibers are melt-blown fibers.

A spunbond fiber which forms the spunbonded non-woven fabric extends in a lengthwise direction of a filament, where an average diameter of the filament is greater than about 5 μm.

The spunbonded non-woven fabric or non-woven web is formed by nonuniformly disposing the spunbond fibers on the surface of a collecting unit such as a porous screen or belt.

The terms “non-woven fabric, fiber web, and non-woven web” used herein refer to a sheet-like structure formed by irregularly disposing separate fibers or threads being bonded together, without a specific pattern in contrast with a knitted fabric. These terms may be used herein interchangeably.

Hereinafter, exemplary embodiments of the present invention will be described in detail with reference to the attached drawings.

An acoustic absorbent according to an embodiment of the present invention includes: a melt-blown fiber having an average diameter in the range of about 0.5 μm to 10 μm; and a polypropylene staple fiber having a diameter in the range of about 10 μm to 200 μm and an average length in the range of about 10 mm to 100 mm. The melt-blown fiber may be prepared by melt-extruding a resin composition including about 90 to 99 wt % of a homo polypropylene and about 1 to 10 wt % of a polypropylene-based elastomer, wherein wt % are relative to the total weight of the resin composition.

Preferably, the melt-blown fiber may be prepared by melt-extruding a resin composition including about 95 to 99 wt % of the homo polypropylene and about 5 to 10 wt % of the polypropylene-based elastomer.

The polypropylene-based elastomer, a copolymer of polypropylene and a comonomer, includes a backbone of saturated hydrocarbons identical to the homo polypropylene and side chains of a comonomer such as ethylene. The polypropylene-based elastomer may have elasticity similar to that of rubber at room temperature due to chain entanglement of the comonomers, and can be repeatedly melted. Examples of commercially available polypropylene-based elastomer include Exxon Mobil's Vistamaxx and Dow's Versify.

As such, the melt-blown fiber prepared by using the resin composition of the present invention is lighter and softer and has better elasticity than a melt-blown fiber prepared by using the homo polypropylene alone.

For example, the resin composition may include a homo polypropylene having a Rockwell hardness (R-scale) in the range of about 90 to 110 and a polypropylene-based elastomer having a density in the range of about 0.85 to 0.89 g/cm³, a Shore hardness (A-type) in the range of about 80 to 100, and a total crystallinity in the range of about 10 to 40%. Such properties of the homo polypropylene and the polypropylene-based elastomer are only examples, and, thus, various modifications may be made to the homo polypropylene and the polypropylene-based elastomer.

The resin composition may be kneaded, extruded, and ejected to prepare melt-blown fibers having an average diameter in the range of about 0.5 to 10 μm. Before the melt-blown fibers are captured to form the fiber web, polypropylene staple fibers are added to the melt-blown fibers. In particular, staple fibers having a diameter in the range of about 10 μm to 200 μm and an average length in the range of about 10 to 100 mm are added to the melt-blown fibers. Preferably, the polypropylene staple fibers are added to the melt-blown fibers such that the content of the polypropylene staple fibers is in the range of about 5 wt % to 50 wt % based on the total weight of the fiber web.

A polypropylene non-woven fabric may be stacked on one or both surfaces of the fiber web. For example, the fiber web may include the described melt-blown fibers and staple fibers which are not oriented in any predetermined direction. The polypropylene non-woven fabric may be stacked on one or both surfaces of the fiber web to a content of about 10 to 100 g/m².

Thus, the acoustic absorbent according to the present invention may further include the polypropylene non-woven fabric on at least one surface of the fiber web, wherein the fiber web includes the melt-blown fibers and the staple fibers.

The acoustic absorbent according to the present invention, which includes the polypropylene staple fibers, particularly polypropylene staple fibers having a diameter in the range of about 10 μm to 200 μm and an average length in the range of about 10 to 100 mm, has better acoustic absorption capability, elasticity, and fixing property (fitting property) as compared with conventional acoustic absorbents. As referred to herein, the fixing property (fitting property) refers to a degree of deformation of the acoustic absorbent so as to correspond to the surface appearance of a product, for example, the interior or exterior components of automobiles. The acoustic absorbent according to the present invention further has excellent elasticity and elongation.

In addition, all of the components of the acoustic absorbent according to the present invention, i.e., the melt-blown fiber, the staple fiber, and the non-woven fabric, are formed of polypropylene with a chemically saturated backbone, and thus they may be 100% recycled.

In addition, since these components are completely recyclable, and may be repeatedly recycled, they are eco-friendly because they do not produce industrial waste.

For example, the acoustic absorbent of the present invention can be recycled and used to prepare an injection molded product of polypropylene. A homo polypropylene having a melt index of 100 or less (at 230° C./2.16 Kg) is generally used for an injection molded product of polypropylene. Further, slices prepared by compressing and cutting an acoustic absorbent according to the present invention to a predetermined size may function as a flow improver in the manufacture of the injection molded product.

The hardness (Rockwell hardness, R-scale) of the homo polypropylene contained in the resin composition (i.e., the resin composition used in the preparation of the melt-blown fiber) may be in the range of about 90 to 110.

If the hardness of the homo polypropylene is less than 90, and the resin composition includes a polypropylene-based elastomer with a lower hardness than the homo polypropylene, then the hardness of the melt-blown fiber is too low to form the fiber web structure. On the other hand, if the hardness of the homo polypropylene is greater than 110, an excess of the polypropylene-based elastomer is required to improve the hardness and elasticity of the melt-blown fiber.

Further, if the content of the polypropylene-based elastomer increases beyond the upper limit defined herein, then the thickness of the melt-blown fiber increases, which may deteriorate acoustic absorption performance.

The diameter of the polypropylene staple fiber of the acoustic absorbent may be in the range of about 10 μm to 200 μm. The polypropylene staple fiber functions as a structure that supports the melt-blown fiber. As such, if the diameter of the polypropylene staple fiber is less than 10 μm, then it may not possess sufficient rigidity to form the supporting structure. On the other hand, if the diameter of the polypropylene staple fiber is greater than about 200 μm, then the weight of the polypropylene staple fiber is excessive such that sufficient acoustic absorption performance may not be provided.

The length of the polypropylene staple fiber of the acoustic absorbent may be in the range of about 10 mm to 100 mm. If the length of the polypropylene staple fiber is less than 10 mm, then the fiber web may not be adequately formed. On the other hand, if the length of the polypropylene staple fiber is greater than about 100 mm, then the polypropylene staple fibers may become entangled and cannot be uniformly dispersed in the fiber web.

The surface of the polypropylene staple fiber may be emulsified with silicon, fluorine, or the like. Since a surface tension of the polypropylene staple fiber is greater than other staple fibers, such as those formed of PET, Nylon, or the like, it is difficult to uniformly distribute a non-emulsified polypropylene staple fiber in the fiber web.

The polypropylene-based elastomer contained in the resin composition is an elastic material including a saturated polypropylene backbone. The polypropylene-based elastomer preferably has a rubber-like elasticity at room temperature and may be repeatedly melt-plasticized by heating at high temperature. The polypropylene-based elastomer may have a density in the range of about 0.85 g/cm³ to 0.89 g/cm³, a Shore hardness (A-type) in the range of about 80 to 100, a total crystallinity in the range of about 10 to 40%, and a melt mass-flow rate of about 25 g/10 min or greater (at 230° C., 2.16 Kg).

By forming the resin composition from the polypropylene-based elastomer in combination with a homo polypropylene that has relatively higher rigidity and relatively lower elasticity and elongation, a melt-blown fiber may be provided with low hardness and excellent elasticity and elongation.

Further, by combining the polypropylene-based elastomer with a rigid homo polypropylene that has relatively higher rigidity and relatively lower elasticity and elongation, the resulting melt-blown fiber may be provided with improved flexibility, lower hardness and better elasticity and elongation than typical superfine fibers. Further, when comparing the acoustic absorption performance of the acoustic absorbent prepared according to the present invention in Example 1 and the acoustic absorbent of Comparative Example 1 (which is further described hereinafter) it is demonstrated that the acoustic absorbent which includes the melt-blown fiber according to the present invention provides better acoustic absorption performance than that of Comparative Example 1.

In addition, since the acoustic absorbent according to the present invention has excellent elasticity and elongation, particularly due to the polypropylene-based elastomer, fitting property thereof onto a product having complicated curved surface (such as automobiles) may be improved.

As described above, the melt mass-flow rate of the polypropylene-based elastomer may be about 25 or greater (at 230° C., 2.16 Kg). If the melt mass-flow rate of the polypropylene-based elastomer is less than 25 (at 230° C., 2.16 Kg), then the polypropylene-based elastomer cannot be uniformly mixed with the highly fluid homo polypropylene. This can result in an increase in the thickness of the melt-blown fiber, which can deteriorate that acoustic absorption performance of the absorbent.

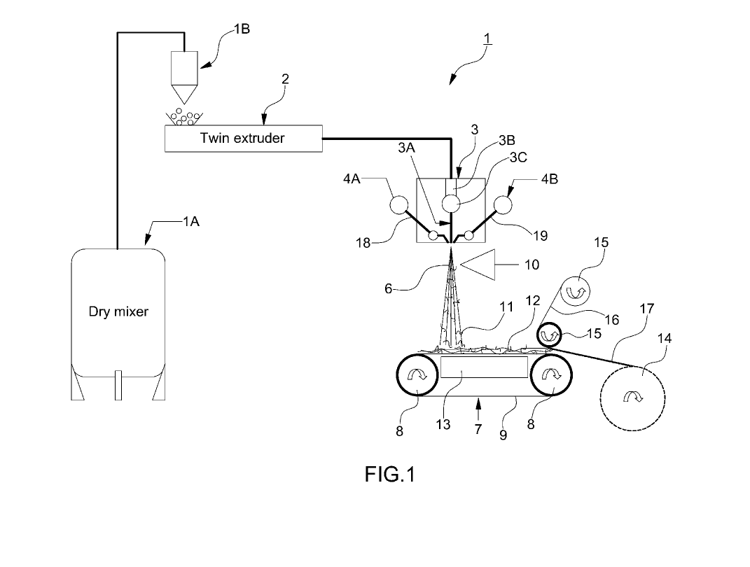

As shown in FIG. 1, an apparatus for manufacturing an acoustic absorbent 1 according to an embodiment of the present invention includes: a mixing unit 1A, such as a dry mixer or the like, that mixes a resin composition of a homo polypropylene and a polypropylene-based elastomer; a drying unit 1B that removes moisture from the mixed resin composition; a heat-extruding unit 2, such as a twin extruder or the like, that heats, kneads, and melts the dried resin composition; a melt-blown fiber ejecting unit 3; a staple fiber discharging unit 10; a capturing unit 7; a stacking unit 15; and a winding unit 14.

According to various embodiments, the resin composition includes X wt % of the homo polypropylene and Y wt % of the polypropylene-based elastomer, particularly wherein 90≦X≦99, 1≦Y≦10, and X+Y=100. Preferably, the resin composition satisfies 90≦X≦95, 5≦Y≦10, and X+Y=100.

Using the apparatus as shown in FIG. 1, the melt-blown fiber ejecting unit 3 receives a melted thermoplastic resin composition from the heat-extruding unit 2 and ejects melt-blown fibers 6 in a filament shape in the longitudinal direction (vertical direction) with gas.

The staple fiber discharging unit 10 is configured and arranged to add polypropylene staple fibers 11 to the ejected melt-blown fibers 6. For example, as shown in FIG. 1, the staple fiber discharging unit 10 may add the polypropylene staple fibers 11 to the melt-blown fibers 6 as they are ejected in the longitudinal direction

The melt-blown fibers 6 and the polypropylene staple fibers 11 are then captured by the capturing unit 7 so as to form a melt-blown fiber web 12.

After the melt-blown fiber web 12 is formed, it proceeds to the stacking unit 15 which stacks a polypropylene non-woven fabric 16 on the fiber web 12 to form the acoustic absorbent 17.

The thus formed acoustic absorbent 17, which includes the polypropylene non-woven fabric 16 stacked on the fiber web 12, then proceeds to the winding unit 14 where it is wound.

According to various embodiments, a polypropylene non-woven fabric 16 or other suitable stacking material may not stacked on the fiber web 12, and thus the stacking unit 15 may not be used.

The fiber web 12 wound by the winding unit 14 and the polypropylene non-woven fabric 16 stacked on one surface of the fiber web 12 constitutes an acoustic absorbent 17 according to the present invention. The wound acoustic absorbent may be trimmed and molded for use in automobiles, buildings, construction machines, and the like.

As shown in FIG. 1, the melt-blown fiber ejecting unit 3 may include an inlet 3B through which the thermoplastic resin composition flows in from the heat-extruding unit 2, a chamber 3C in which the thermoplastic resin composition flowed in from the inlet 3B can be temporarily stored, and a plurality of filament ejecting pipes 3A extending from the chamber 3C toward the capturing unit 7. In this regard, the melt-blown fiber ejecting unit 3 may include vertical gas ejecting units 4A and 4B that eject gas toward the filament in order to extend the melt-blown fiber 6 ejected from the filament ejecting pipe 3A in the longitudinal direction (vertical direction).

The vertical gas ejecting units 4A and 4B may be symmetrically disposed at both sides of the filament ejecting pipe 3A as shown in FIG. 1. In addition, gas jet nozzles 18 and 19 may be provided in the vertical gas ejecting units 4A and 4B. As shown, the which may be disposed at an inclined position with respect to the vertical direction.

The gas jet nozzles 18 and 19 may be disposed such that a direction of a resultant force of the gases ejected from the gas jet nozzles 18 and 19 is the longitudinal direction (vertical direction). For example, if the gas jet nozzles 18 and 19 may be symmetrically disposed at both sides of the filament ejecting pipe 3A with respect to the longitudinal direction, then the direction of the resultant force of the gases ejected from the gas jet nozzles 18 and 19 is the longitudinal direction (vertical direction).

Accordingly, the melt-blown fiber 6 ejected from the filament ejecting pipe 3A extends in the lengthwise direction by collision with the gas ejected by the gas jet nozzles 18 and 19. As the melt-blown fiber 6 is extended in the lengthwise direction, the diameter of the melt-blown fiber 6 is reduced. According to various embodiments, the gas ejected from the gas jet nozzles 18 and 19 may be a hot and/or high-speed gas, which may further reduce the diameter of the melt-blown fiber 6. Any suitable gas may be used, such as air. The gas may also be a gas including nitrogen gas, oxygen gas, and water vapor. These gases may be provided in combination with each other and/or with other gases at various ratios, or the gas can be a single-component inert gas. The types of the gas may also be modified in various other ways.

In this regard, when referring to a hot gas, “hot” indicates a temperature equal to or higher than room temperature (25° C.), and may be any temperature sufficient for the melt-blown fiber 6 to extend in the lengthwise direction. Thus, the temperature of the gas discharged from the melt-blown fiber ejecting unit 3 may vary, and when the gas is hot, it may vary within the noted range.

In addition, when referring to high speed gas ejection, “high-speed” generally indicates a speed sufficient for the gas to be discharged with a predetermined orientation. Thus, the speed of the discharged gas may vary, and when the gas is ejected at high speed, any speed that provides the desired discharge can be used.

As shown and described, the staple fiber discharging unit 10 adds the staple fibers 11 to the ejected melt-blown fibers 6. The staple fiber discharging unit 10 may add the staple fibers 11 to the melt-blowing fibers 6 by a relative pressure difference caused by air pressure or air flow generated by the ejected melt-blown fibers 6. According to various embodiments, the staple fibers 11 may be added to the melt-blown fibers 6 by scattering the staple fibers 11 onto the capturing unit 7. In this regard, the position of the staple fiber discharging unit 10, which is shown in one exemplary embodiment in FIG. 1, may also be modified in various ways. In particular, the staple fiber discharging unit 10 may be provided in any position as long as the staple fibers 11 are added to the melt-blown fibers 6 before the polypropylene non-woven fabric 16 is stacked on the fiber web 12 by the stacking unit 15.

The capturing unit 7 may include a belt 9 on which the ejected melt-blown fibers 6 and the staple fibers 11 are captured, and a pair of rollers 8 that operate the belt 9.

As shown in FIG. 1, the apparatus 1 may further include a ventilator 13 that absorbs the gas discharged from the vertical gas ejecting units 4A and 4B and forms a gas flow toward the belt 9 under the belt 9. In this regard, if the ventilator 13 is disposed under the belt 9, the belt 9 may have one or more apertures (not shown) through which the gas passes. In some embodiments, the ventilator 13 may not be used.

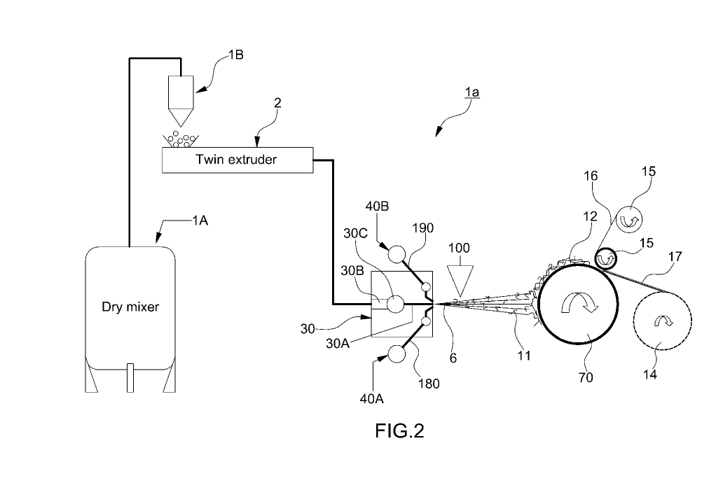

Hereinafter, an apparatus for manufacturing an acoustic absorbent 1a according to another embodiment of the present invention will be described with reference to FIG. 2.

As shown in FIG. 2, the apparatus for manufacturing an acoustic absorbent 1a includes: a mixing unit 1A, such as a dry mixer or the like, that mixes the resin composition of a homo polypropylene and a polypropylene-based elastomer in a predetermined ratio; a drying unit 1B that removes moisture from the mixed resin composition; a heat-extruding unit 2, such as a twin extruder or the like, that heats, kneads, and melts the dried resin composition; a melt-blown fiber ejecting unit 30; a staple fiber discharging unit 100; a capturing unit 70; a stacking unit 15; and a winding unit 14.

The apparatus 1a of the embodiment shown in FIG. 2 differs from the apparatus 1 of the embodiment shown in FIG. 1 in that the melt-blown fiber ejecting unit 30 ejects the melt-blown fiber 6 in the lateral direction (horizontal direction, i.e., a direction perpendicular to the gravitational direction).

As shown, the melt-blown fiber ejecting unit 30 receives a melted thermoplastic resin composition from the heat-extruding unit 2 and ejects the melt-blown fibers 6 in a filament shape in the horizontal direction with gas.

The staple fiber discharging unit 100 adds staple fibers, such as polypropylene staple fibers 11, to the ejected melt-blown fibers 6. For example, as shown in FIG. 2, the staple fiber discharging unit 100 may add the polypropylene staple fibers 11 to the melt-blown fibers 6 as they are ejected in the lateral direction

The capturing unit 70 then captures the melt-blown fibers 6 and the polypropylene staple fibers 11 to form a melt-blown fiber web 12.

After formation of the melt-blown fiber web 12, the stacking unit 15 then stacks a polypropylene non-woven fabric 16 on the fiber web 12 to form the acoustic absorbent 17.

The thus formed acoustic absorbent 17, which includes the polypropylene non-woven fabric 16 stacked on the fiber web 12, then proceeds to the winding unit, which 14 winds an acoustic absorbent 17.

According to various embodiments, a polypropylene non-woven fabric 16 or other suitable stacking material may not stacked on the fiber web 12, and thus the stacking unit 15 may not be used.

The acoustic absorbent 17 wound by the winding unit 14 may be trimmed and molded for use in automobiles, buildings, construction machines, and the like.

As shown in the embodiment of FIG. 2, the melt-blown fiber ejecting unit 30 includes an inlet 30B through which the thermoplastic resin composition flows in from the heat-extruding unit 2, a chamber 30C in which the thermoplastic resin composition flowed from the inlet 30B may be temporarily stored, and a plurality of filament ejecting pipes 30A extending from the chamber 30C toward the capturing unit 70.

As shown in FIG. 2, the melt-blown fiber ejecting unit 30 may further include horizontal gas ejecting units 40A and 40B that eject gas toward the filament in order to extend the melt-blown fiber 6 ejected from the filament ejecting pipe 30A in the lateral direction (horizontal direction). The horizontal gas ejecting units 40A and 40B may be symmetrically disposed at both sides of the filament ejecting pipe 30A as shown in FIG. 2. Further, gas jet nozzles 180 and 190 may be provided in the horizontal gas jet units 40A and 40B. As shown, the gas jet nozzles 180 and 190 may be disposed to be inclined with respect to the lateral direction (horizontal direction).

The gas jet nozzles 180 and 190 may be disposed such that a direction of a resultant force of the gases ejected from the gas jet nozzles 180 and 190 is in the lateral direction (horizontal direction). For example, if the gas jet nozzles 180 and 190 are symmetrically disposed at both sides of the filament ejecting pipe 30A with respect to the longitudinal direction, the direction of the resultant force of the gases ejected from the gas jet nozzles 180 and 190 will be the lateral direction (horizontal direction).

As shown in FIG. 2, the staple fiber discharging unit 100 adds the staple fibers 11 to the ejected melt-blown fibers 6. The staple fiber discharging unit 10 may add the staple fibers 11 to the melt-blowing fibers 6 by a relative pressure difference caused by air pressure or air flow generated by the ejected melt-blown fibers 6. In some embodiments, the staple fibers 11 may be added to the melt-blown fibers 6 by scattering the staple fiber 11 onto the capturing unit 70. In this regard, the position of the staple fiber discharging unit 100, which is shown in one exemplary embodiment in FIG. 2, may also be modified in various ways. In particular, the staple fiber discharging unit 10 may be provided in any position as long as the staple fibers 11 are added to the melt-blown fibers 6 before the polypropylene non-woven fabric 16 is stacked by the stacking unit 15.

According to a method of manufacturing an acoustic absorbent according to an embodiment of the present invention, first, a resin composition including X wt % of a homo polypropylene and Y wt % of a polypropylene-based elastomer is melt-extruded, wherein 90≦X99, 1≦Y10, and X+Y=100. Preferably, the resin composition satisfies the following condition: 90≦X≦95, 5≦Y≦10, and X+Y=100.

The melted thermoplastic resin is then ejected into a fiber shape with gas (gas ejection). Staple fibers, particularly polypropylene staple fibers having a diameter in the range of about 10 μm to 200 μm and an average length in the range of about 10 mm to 100 mm are then added to the ejected melt-blown fibers. The ejected melt-blown fibers and the staple fibers are captured by a suitable capture unit to form a fiber web. The thus formed fiber web may then be wound.

According to embodiments of the invention, the step of adding the staple fiber can comprise adding about 5 to 50 wt % staple fiber based on the total weight of the fiber web.

In addition, the method may further include stacking a polypropylene non-woven fabric on at least one surface of the wound fiber web. In particular, prior to winding the fiber web, a polypropylene non-woven fabric may be stacked on at least one surface of the wound fiber web.

As described above, a hardness (Rockwell hardness, R-scale) of the homo polypropylene contained in the resin composition may be in the range of about 90 to 110.

### EXAMPLES

The present invention will now be described in greater detail with reference to the following examples. The following examples are for illustrative purposes only and are not intended to limit the scope of the invention.

18 types of acoustic absorbents were prepared according to the present invention by using various amounts of the polypropylene-based elastomer in the resin composition used to prepare the melt-blown fiber, and by adding various amounts of the polypropylene staple fiber based on the total weight of the fiber web. Then, elongation and elasticity of a machine direction and a cross direction, and acoustic absorption performance of the acoustic absorbents according to the present invention were measured and compared with absorbents prepared in Comparative Examples 1 and 2. Hereinafter, the results will be described.

### (1) Example 1

An acoustic absorbent was prepared by using an apparatus for manufacturing an acoustic absorbent 1 that ejects a melt-blown fiber in the vertical direction, as shown in FIG. 1. Conditions for the preparation are as follows.

99 wt % of a homo polypropylene (grade H7914) obtained from LG Chem Ltd. having a hardness (Rockwell hardness, R-scale) of 105 and a melt index of 1400 g/10 min at 230° C., and 1 wt % of a polypropylene-based elastomer (Versify 4200) obtained from The Dow Chemical Company were added to a mixing unit 1A and mixed for 10 minutes. Physical properties of Versify 4200 are shown in Table 1 below.

TABLE 1

| Property | Value | | Test Method |
|---|---|---|---|
| Density | 0.876 | g/cm³ | ASTM D792 |
| Melt mass-flow rate | 25 | g/10 min | ASTM D1238 |
| (230° C./2.16 Kg) | | | |
| Total crystallinity | 29% | | Dow Method |
| Hardness (shore A) | 94 | | ASTM D2240 |
| Glass transition temperature (DSC) | −23° | C. | Dow Method |

The mixed composition was transferred to a drying unit 1B and were stirred 80 times per minute, kneaded and extruded in the heat-extruding unit 2 having a length/dimension ratio of 1/28. Then, the melted resin composition was ejected toward the capturing unit 7 via a filament ejecting pipe 3A of the melt-blown fiber ejecting unit 3. The melt-blown fiber ejecting unit 3 had a diameter of 2 m and included 32 orifices per inch, wherein each orifice had a diameter of 0.25 mm. As the melted resin composition was ejected, air heated to 200° C. was simultaneously discharged to collide with the melt-blown fiber ejected via the vertical gas ejecting units 4A and 4B of the melt-blown fiber ejecting unit 3 so that an average diameter of the melt-blown fiber was 3 μm.

Here, the gas jet nozzles 18 and 19 were inclined with respect to the vertical direction such that an angle therebetween was 100 degrees.

The staple fiber discharging unit 10 was disposed at a point spaced 10 cm apart from the melt-blown fiber ejecting unit 3 in a direction toward the capturing unit 7. The diameter and average length of the staple fibers discharged from the staple fiber discharging unit 10 were 40 μm and 39 mm, respectively. The input of the staple fiber was adjusted such that the content of the staple fiber was 5 wt % based on the total weight of a fiber web including the melt-blown fiber and the staple fiber.

In addition, a perpendicular distance between the melt-blown fiber ejecting unit 3 and the capturing unit 7 was set to 80 cm, and the speed of the capturing unit 7 was adjusted such that a weight of the fiber web per unit area was 200 g/m².

After formation of the fiber web, the winding unit 14 wound the fiber web having a weight of 200 g/m² to a length of 100 meters (M) A polypropylene spunbonded non-woven fabric having a weight of 15 g/m² was stacked on both surfaces of the wound fiber web to prepare an acoustic absorbent having a total weight per unit area of 230 g/m².

### (2) Examples 2 to 6

Fiber webs were prepared in the same manner as in Example 1, except that the weight of the polypropylene staple fiber constituting each fiber web was 10, 20, 30, 40, and 50 wt % respectively based on the total weight of the fiber web. The polypropylene spunbonded non-woven fabric, having a weight of 15 g/m², was stacked on both surfaces of the fiber web to prepare an acoustic absorbent having a total weight per unit area of 230 g/m².

That is, the contents of the polypropylene staple fibers of the acoustic absorbents prepared according to Examples 2 to 6 were 10 wt % (Example 2), 20 wt % (Example 3), 30 wt % (Example 4), 40 wt % (Example 5), and 50 wt % (Example 6), respectively, based on the weight of the fiber web, when compared with the 5 wt % used in the acoustic absorbent prepared according to Example 1.

### (3) Example 7

A fiber web was prepared in the same manner as in Example 1, except that the thermoplastic resin composition used to form the melt-blown fiber included 95 wt % of the homo polypropylene (H7914) and 5 wt % of the polypropylene elastomer (Versify 4200). A polypropylene spunbonded non-woven fabric having a weight per unit area of 15 g/m² was stacked on both surfaces of the fiber web to prepare an acoustic absorbent having a total weight per unit area of 230 g/m².

### (4) Examples 8 to 12

Fiber webs were prepared in the same manner as in Example 7, except that the weights of the polypropylene staple fiber constituting each fiber web was 10 wt % (Example 8), 20 wt % (Example 9), 30 wt % (Example 10), 40 wt % (Example 11), and 50 wt % (Example 12), respectively, based on the total weight of the fiber web. A polypropylene spunbonded non-woven fabric having a weight per unit area of 15 g/m² was stacked on both surfaces of the fiber web to prepare acoustic absorbents having a total weight per unit area of 230 g/m² according to Examples 8 to 12.

### (5) Example 13

A fiber web was prepared in the same manner as in Example 1, except that the thermoplastic resin composition used to form the melt-blown fiber included 90 wt % of the homo polypropylene (H7914) and 10 wt % of the polypropylene-based elastomer (Versify 4200). A polypropylene spunbonded non-woven fabric having a weight per unit area of 15 g/m² was stacked on both surfaces of the fiber web to prepare an acoustic absorbent having a total weight per unit area of 230 g/m².

### (6) Examples 14 to 18

Fiber webs were prepared in the same manner as in Example 13, except that the weight of the polypropylene staple fiber constituting each fiber web was 10 wt % (Example 14), 20 wt % (Example 15), 30 wt % (Example 16), 40 wt % (Example 17), and 50 wt % (Example 18), respectively, based on the total weight of the fiber web. A polypropylene spunbonded non-woven fabric having a weight per unit area of 15 g/m² was stacked on both surfaces of the fiber web to prepare acoustic absorbents having a total weight per unit area of 230 g/m² according to Examples 14 to 18.

### (7) Comparative Example 1

A melt-blown fiber was prepared in the same manner as in Example 1, except that a resin used to prepare the melt-blown fiber included 100 wt % of the homo polypropylene (H7914). That is, the polypropylene-based elastomer was not added to the resin. A polypropylene staple fiber was added to the melt-blown fiber prepared using a melted resin including 100 wt % of the homo polypropylene such that the weight of the polypropylene staple fiber was 5 wt % based on the total weight of the fiber web.

A polypropylene spunbonded non-woven fabric having a weight per unit area of 15 g/m² was stacked on both surfaces of the fiber web to prepare an acoustic absorbent according to Comparative Example 1 having a total weight per unit area of 230 g/m².

### (8) Comparative Example 2

A melt-blown fiber was prepared in the same manner as in Example 1, except that a resin used to prepare the melt-blown fiber included 100 wt % of the homo polypropylene (H7914). That is, the polypropylene-based elastomer was not added to the resin. In addition, a fiber web having a weight per unit area of 200 g/m² was prepared only using the melt-blown fiber without adding the polypropylene staple fiber to the melt-blown fiber. A polypropylene spunbonded non-woven fabric having a weight per unit area of 15 g/m² was stacked on both surfaces of the fiber web to prepare an acoustic absorbent according to Example 2 having a total weight per unit area of 230 g/m².

Table 2 below shows conditions for the preparation of the acoustic absorbents according to Examples 1 to 18 and Comparative Examples 1 and 2 and test results of the acoustic absorbents.

TABLE 2

| | Total | Content of | | | | | |
|---|---|---|---|---|---|---|---|
| | weight of | propylene- | Content of | | | | |
| | acoustic | based | propylene | Thickness of | MD tensile | CD tensile | Compressive |
| | absorbent | elastomer | staple fiber | fiber web | elongation | elongation | elasticity |
| | (g/m²) | (wt %) | (wt %) | (mm) | (%) | (%) | (%) |
| Example 1 | 230 | 1 | 5 | 7 | 51 | 60 | 55 |
| Example 2 | 230 | 1 | 10 | 8 | 50 | 58 | 60 |
| Example 3 | 230 | 1 | 20 | 9 | 49 | 60 | 67 |
| Example 4 | 230 | 1 | 30 | 10 | 50 | 61 | 70 |
| Example 5 | 230 | 1 | 40 | 12 | 51 | 59 | 75 |
| Example 6 | 230 | 1 | 50 | 13 | 51 | 61 | 79 |
| Example 7 | 230 | 5 | 5 | 7 | 59 | 69 | 54 |
| Example 8 | 230 | 5 | 10 | 8 | 60 | 71 | 61 |
| Example 9 | 230 | 5 | 20 | 9 | 58 | 70 | 68 |
| Example 10 | 230 | 5 | 30 | 10 | 59 | 69 | 71 |
| Example 11 | 230 | 5 | 40 | 12 | 60 | 68 | 74 |
| Example 12 | 230 | 5 | 50 | 13 | 62 | 72 | 80 |
| Example 13 | 230 | 10 | 5 | 7 | 65 | 75 | 53 |
| Example 14 | 230 | 10 | 10 | 8 | 67 | 73 | 80 |
| Example 15 | 230 | 10 | 20 | 9 | 65 | 72 | 65 |
| Example 16 | 230 | 10 | 30 | 10 | 64 | 73 | 71 |
| Example 17 | 230 | 10 | 40 | 12 | 66 | 75 | 72 |
| Example 18 | 230 | 10 | 50 | 13 | 65 | 71 | 77 |
| Comparative | 230 | — | 5 | 7 | 42 | 49 | 55 |
| Example 1 | | | | | | | |
| Comparative | 230 | — | — | 8 | 43 | 50 | 45 |
| Example 2 | | | | | | | |

In Table 2, the MD refers to a machine direction, and the CD refers to a cross direction.

Referring to Table 2, the following results were demonstrated.

First, it was demonstrated that tensile elongation of the acoustic absorbent is improved as the content of the polypropylene-based elastomer in the resin composition increases. Particularly, the tensile elongation is improved by from 10% to 54% for the present acoustic absorbents which include the polypropylene-based elastomer, as compared with the acoustic absorbent prepared in Comparative Example 1 in which the polypropylene-based elastomer is not included.

Second, it was demonstrated that the thickness and compressive modulus of elasticity of the acoustic absorbent is increased as the content of the polypropylene staple fiber increases in the acoustic absorbent according to the present invention.

Third, when the acoustic absorbents according to Examples 1, 7, and 13 were compared with those according to Examples 2, 8, and 14, in which the amounts of the polypropylene staple fiber were the same while the amounts of the polypropylene-based elastomer were different from each other, it was demonstrated that the polypropylene-based elastomer improves tensile elongation but does not affect the compressive elasticity of the acoustic absorbent.

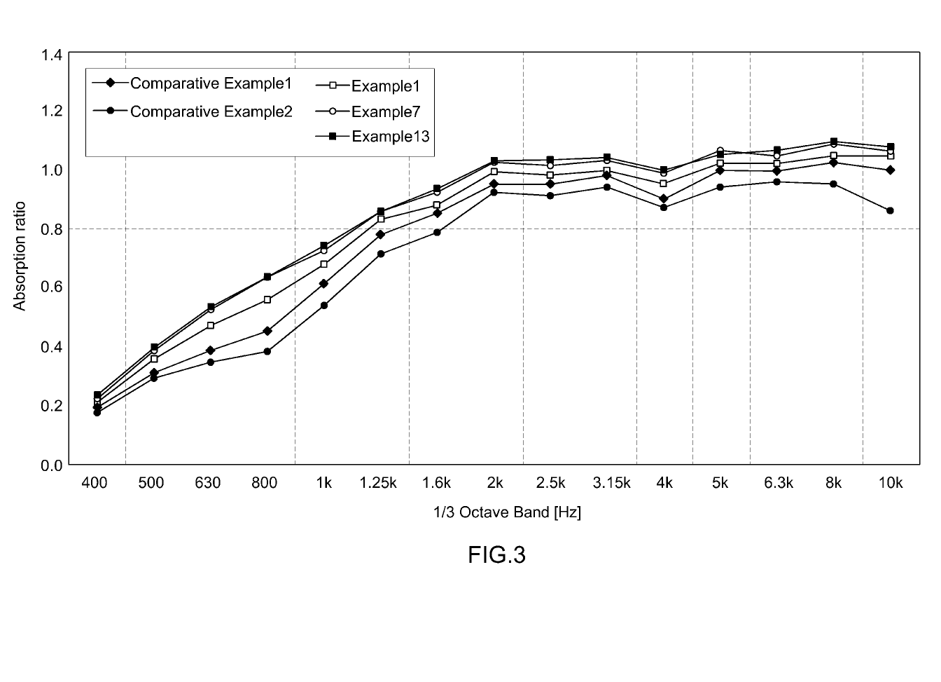

Acoustic absorption performance of the acoustic absorbents prepared according to Examples 1 to 18 and Comparative Examples 1 and 2 will be further described with reference to the graphs shown in FIGS. 3-8 which illustrate test results of the acoustic absorbents.

As shown in FIG. 3, the acoustic absorption performance decreases in the following order: Example 13 (10 wt % of the polypropylene-based elastomer based on the weight of the resin composition)>Example 7 (5 wt % of the polypropylene-based elastomer based on the weight of the resin composition)>Example 1 (1 wt % of the polypropylene-based elastomer based on the weight of the resin composition)>Comparative Example 1 (no polypropylene-based elastomer)>Comparative Example 2 (no polypropylene-based elastomer). Therefore, it was demonstrated that the acoustic absorption performance of the acoustic absorbent increases as the content of the polypropylene-based elastomer increases.

As set out, the acoustic absorbent of Comparative Example 1 was prepared using 100 wt % of the homo polypropylene without using the polypropylene-based elastomer, and the content (5 wt %) of the polypropylene staple fiber was the same as that of the acoustic absorbents of Examples 1, 7, and 13.

As shown in FIG. 3, it was demonstrated that the acoustic absorption performance of the acoustic absorbents including the polypropylene-based elastomer prepared in Examples 1, 7, and 13 was better than that of Comparative Example 1 even when Comparative Example 1 contained the same amount of the polypropylene staple fiber as Examples 1, 7, and 13.

Accordingly, it was further demonstrated that the acoustic absorption performance was improved by adding the polypropylene-based elastomer.

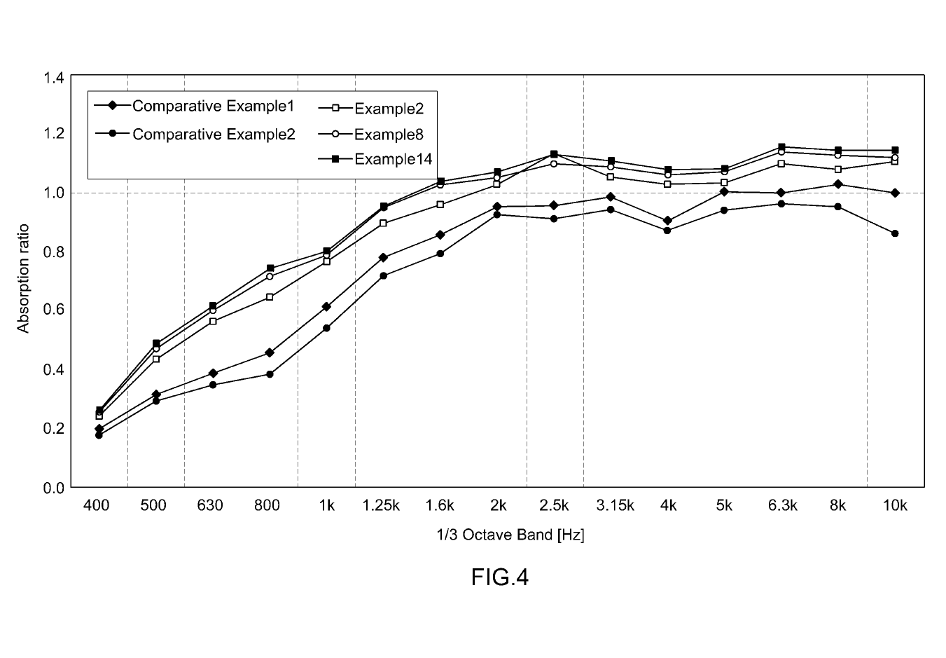

As shown in FIG. 4, the acoustic absorption performance decreases in the following order: Example 14 (10 wt % of the polypropylene-based elastomer based on the weight of the resin composition)>Example 8 (5 wt % of the polypropylene-based elastomer based on the weight of the resin composition)>Example 2 (1 wt % of the polypropylene-based elastomer based on the weight of the resin composition)>Comparative Example 1 (no polypropylene-based elastomer)>Comparative Example 2 (no polypropylene-based elastomer). Accordingly, it was demonstrated that the acoustic absorption performance of the acoustic absorbent increases as the content of the polypropylene-based elastomer increases.

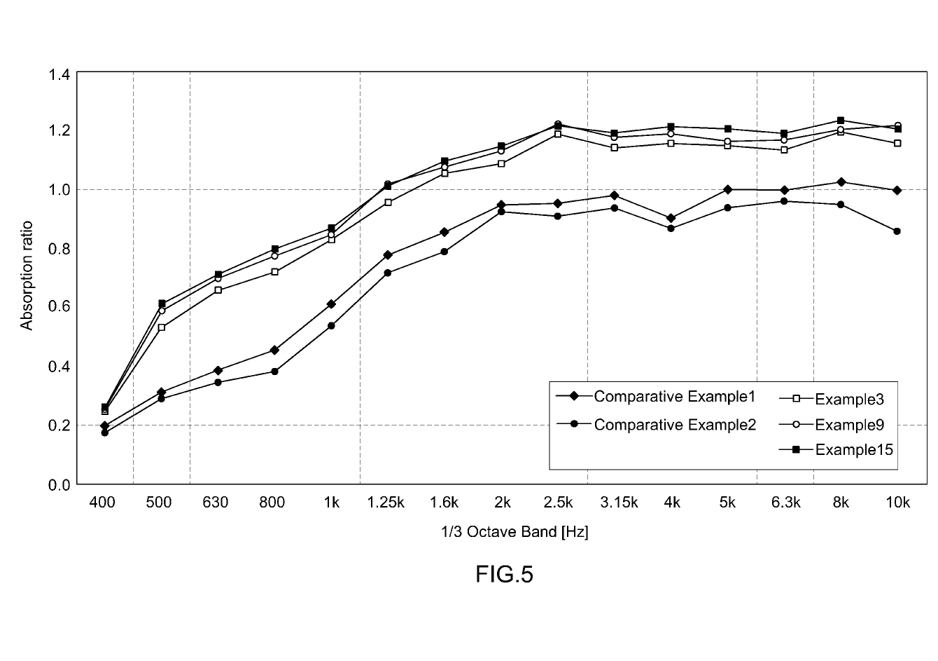

As shown in FIG. 5, the acoustic absorption performance decreases in the following order: Example 15 (10 wt % of the polypropylene-based elastomer based on the weight of the resin composition)>Example 9 (5 wt % of the polypropylene-based elastomer based on the weight of the resin composition)>Example 3 (1 wt % of the polypropylene-based elastomer based on the weight of the resin composition)>Comparative Example 1 (no polypropylene-based elastomer)>Comparative Example 2 (no polypropylene-based elastomer). Accordingly, it was further demonstrated that the acoustic absorption performance of the acoustic absorbent increases as the content of the polypropylene-based elastomer increases.

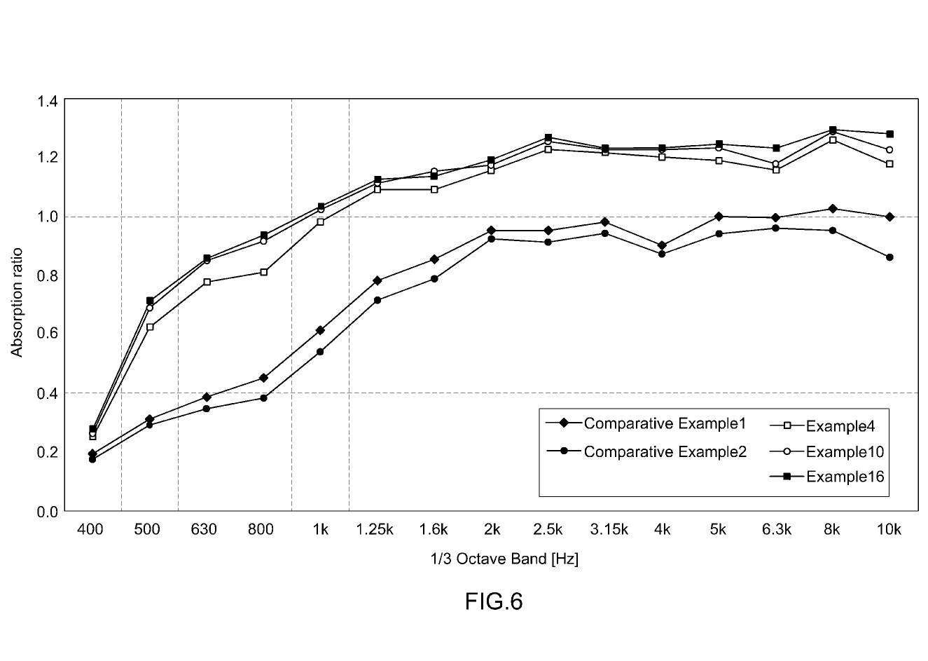

As shown in FIG. 6, the acoustic absorption performance decreases in the following order: Example 16 (10 wt % of the polypropylene-based elastomer based on the weight of the resin composition)>Example 10 (5 wt % of the polypropylene-based elastomer based on the weight of the resin composition)>Example 4 (1 wt % of the polypropylene-based elastomer based on the weight of the resin composition)>Comparative Example 1 (no polypropylene-based elastomer)>Comparative Example 2 (no polypropylene-based elastomer). Accordingly, it was further demonstrated that the acoustic absorption performance of the acoustic absorbent increases as the content of the polypropylene-based elastomer increases.

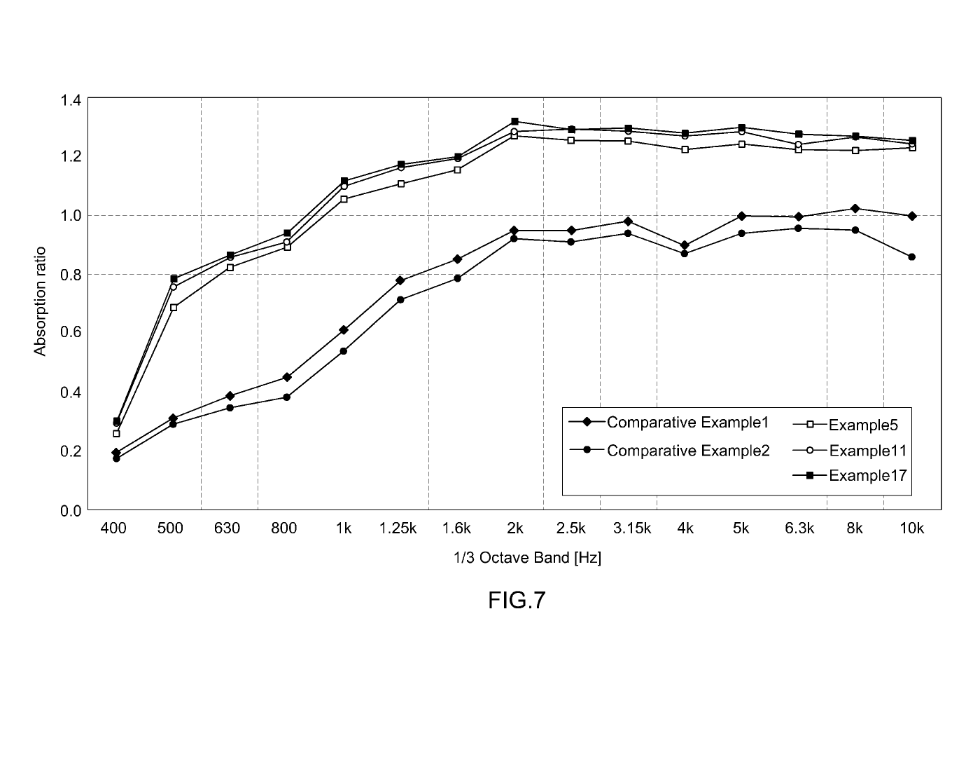

As shown in FIG. 7, the acoustic absorption performance decreases in the following order: Example 17 (10 wt % of the polypropylene-based elastomer based on the weight of the resin composition)>Example 11 (5 wt % of the polypropylene-based elastomer based on the weight of the resin composition)>Example 5 (1 wt % of the polypropylene-based elastomer based on the weight of the resin composition)>Comparative Example 1 (no polypropylene-based elastomer)>Comparative Example 2 (no polypropylene-based elastomer). Accordingly, it was further demonstrated that the acoustic absorption performance of the acoustic absorbent increases as the content of the polypropylene-based elastomer increases.

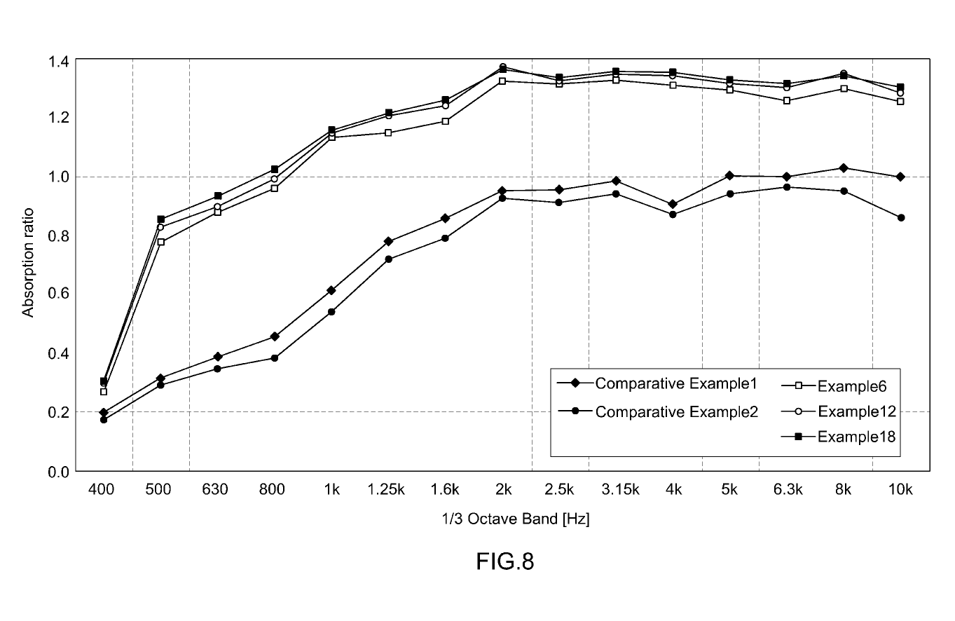

As shown in FIG. 8, the acoustic absorption performance decreases in the following order: Example 18 (10 wt % of the polypropylene-based elastomer based on the weight of the resin composition)>Example 12 (5 wt % of the polypropylene-based elastomer based on the weight of the resin composition)>Example 6 (1 wt % of the polypropylene-based elastomer based on the weight of the resin composition)>Comparative Example 1 (no polypropylene-based elastomer)>Comparative Example 2 ((no polypropylene-based elastomer). Accordingly, it was further demonstrated that the acoustic absorption performance of the acoustic absorbent increases as the content of the polypropylene-based elastomer increases.

Influence of the content of the polypropylene staple fiber on the acoustic absorption performance may be observed by comparing the acoustic absorption performance of the acoustic absorbent of Example 1 (FIG. 3) with that of Example 2 (FIG. 4). The content of the polypropylene-based elastomer was 1 wt % in both Examples 1 and 2, while the content of the polypropylene staple fiber was 5 wt % in Example 1 and 10 wt % in Example 2 based on the total weight of the fiber web.

As shown in FIGS. 3 and 4, it was demonstrated that the acoustic absorption performance of the acoustic absorbent of Example 2 was better than that of Example 1. In particular, as the content of the staple fiber increases, the thickness of the acoustic absorbent also increases, which results in a relative increase in the acoustic absorption performance.

In other words, as the content of the polypropylene-based elastomer in the resin composition increases, and as the content of the polypropylene staple fiber increases, the acoustic absorption performance is improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An acoustic absorbent comprising a fiber web that comprises:
a melt-blown fiber prepared by melt-extruding a resin composition comprising about 90 to 99 wt % of a homo polypropylene and about 1 to 10 wt % of a polypropylene-based elastomer, based on a total weight of the resin composition; and
a polypropylene staple fiber.

2. The acoustic absorbent of claim 1, wherein the content of the homo polypropylene is in the range of about 90 to 95 wt % and the content of the polypropylene-based elastomer is in the range of about 5 to 10 wt %, based on a total weight of the resin composition.

3. The acoustic absorbent of claim 1, wherein a diameter of the melt-blown fiber is in the range of about 0.5 to 10 μm.

4. The acoustic absorbent of claim 3, wherein a diameter of the melt-blown fiber is in the range of about 5 to 10 μm.

5. The acoustic absorbent of claim 1, wherein the staple fiber has a diameter in the range of about 10 to 200 μm and an average length in the range of about 10 to 100 mm.

6. The acoustic absorbent of claim 1, wherein the content of the polypropylene staple fiber is in the range of about 5 to 50 wt % based on the total weight of the fiber web.

7. The acoustic absorbent of claim 6, wherein the content of the polypropylene staple fiber is in the range of about 40 to 50 wt % based on the total weight of the fiber web.

8. The acoustic absorbent of claim 1, wherein the fiber web further comprises a polypropylene non-woven fabric.

9. The acoustic absorbent of claim 1, wherein a hardness (Rockwell hardness, R-scale) of the homo polypropylene is in the range of about 90 to 110.

10. A method of manufacturing an acoustic absorbent, the method comprising:
melt-extruding a resin composition comprising about 90 to 99 wt % of a homo polypropylene and about 1 to 10 wt % of a polypropylene-based elastomer, based on a total weight of the resin composition;
ejecting the melted thermoplastic resin in a melt-blown fiber shape with gas;
adding a polypropylene staple fiber to the ejected melt-blown fiber;
capturing the ejected melt-blown fiber and the staple fiber to form a fiber web; and
winding the fiber web.

11. The method of claim 10, wherein the content of the homo polypropylene is in the range of about 90 to 95 wt % and the content of the polypropylene-based elastomer is in the range of about 5 to 10 wt % based on a total weight of the resin composition.

12. The method of claim 10, wherein a diameter of the ejected melt-blown fiber is in the range of about 0.5 to 10 μm.

13. The method of claim 10, wherein the step of adding the polypropylene staple fiber comprises adding a polypropylene staple fiber having a diameter in the range of about 10 to 200 μm and an average length in the range of about 10 to 100 mm.

14. The method of claim 10, wherein the step of adding the polypropylene staple fiber comprises adding the polypropylene staple fiber comprises adding the polypropylene staple fiber such that a content of the polypropylene staple fiber is in the range of about 5 to 50 wt % based on the total weight of the fiber web.

15. The method of claim 10, further comprising, after forming the fiber web, stacking a polypropylene non-woven fabric on the fiber web.

16. The method of claim 10, wherein a hardness (Rockwell hardness, R-scale) of the homo polypropylene is in the range of about 90 to 110.
